(19) United States
(12) Patent Application Publication
(10) Pub. No.: US 2005/0108241 A1
(43) Pub. Date: May 19, 2005

(54) Method for designing low cost static networks

(75) Inventors: Krishna Gopal Depura, Bangalore (IN); Sarath Kumar, Bangalore (IN); Amit Agrawal, Bangalore (IN); Sanjay Patnaik, Bangalore (IN)

Correspondence Address: MERCHANT & GOULD PC, P.O. BOX 2903, MINNEAPOLIS, MN, 55402-0903, US

(73) Assignee: Tejas Networks India Pvt. Ltd., Bangalore (IN)

(21) Appl. No.: 10/491,691

(22) PCT Filed: Oct. 4, 2001
(86) PCT No.: PCT/IN01/00169

(51) Int. Cl. G06F 7/00

(52) U.S. Cl. 707/10

(57) ABSTRACT

The present invention relates to a method for designing networks, more particularly to a method for designing lost cost static telecommunication networks (101) with failure protection (404), which results in an efficient utilization of network elements (nodes) and transmission links (Links).

### FIELD OF THE INVENTION

The present invention relates to a method for designing networks, more particularly to a method for designing lost cost static telecommunication networks with failure protection, which results in an efficient utilization of network elements and transmission link capacities and which supports a static Demand set, such that a Demand can be restored or switched to a pre-configured capacity, in case of failure of one or more of these Demands due to failures, such as transmission link failures, in the network.

### BACKGROUND DESCRIPTION

A network design starts with the choice of the transmission equipment based on the general size of the network and the amount of data, that it is expected to carry between various nodes, where data can be anything like traffic, signals or any type of information. The Applicants will call this data capacity required between two nodes as “Demand” between these two nodes. Once this choice of equipment is made, then traffic engineering gives us all the information required for equipment configurations at each of the network nodes. The purpose of traffic engineering is to arrive at a route assignment, link capacity sizing, node equipment sizing, and transmission link assignment to each of the Demands, such that it results in a low cost network. A detailed idea about networks and more references regarding this can be found in Chapter 6, 7 and 8 of the book “Optical Networks: A practical perspective” by Rajiv Ramaswami and Kumar N. Sivarajan, Morgan Kaufmann Publisher, 1998. For a better understanding of network design issues and optimization techniques, please see the book “Wide Area Network Design” by Robert S. Cahn, Morgan Kaufmann, 1998.

Designing a network is a two-stage process. In the first stage, given a network topology, decision is made on the service and protection routes (in case of protected networks) for each Demand. Many different route assignment schemes are possible as each Demand can have several combinations of service and protection routes. This phase is called route assignment phase and such set, which satisfies the complete Demand set, is called Route Assignment (RA). In the second stage, given a RA, transmission link capacity assignment is made efficient. This phase is called as Capacity Assignment phase and this solution will be called Capacity Assignment (CA). A paper “Optical Network Design and Restoration”, by Bharat T. Doshi, Subrahmanyam Dravida, P. Harshavardhana, Oded Hauser and Yufei Wang, in Bell Labs technical Journal, January-March 1999, gives a very good insight into this two-stage problem formulation in communication networks.

The problem of finding an optimum network design is found to be difficult to solve. Much of the prior art tackles the two stages of this problem separately. Optimum solution in each stage, when combined would not give an over-all optimum solution. The Applicants in the present invention have devised a novel method wherein the two-stage problem is not solved separately but the problem in both the stages are solved together using an intelligent heuristic to give low cost static network design. In the present invention, the Applicants select a RA depending upon some parameters and do a CA for the particular RA. Further, the Applicants generate a feedback from this newly generated CA which gives a feedback about this RA in terms of the efficient utilization of link capacity and network cost. Using this feedback from CA, the Applicants perturb the RA intelligently to come up with a new set of better RA. This process is repeated till no better RA is obtained by perturbing the parent RA. This is a very fast and efficient method because it takes both the problems of RA and CA together and it converges to a good solution very fast as it is based on intelligent feedback method.

### SUMMARY OF THE INVENTION

The present invention relates to a method for designing networks, more particularly to a method for designing lost cost static telecommunication networks with failure protection, which results in an efficient utilization of network elements and transmission link capacities and which supports a static Demand set, such that a Demand can be restored or switched to a pre-configured capacity, in case of failure of one or more of these Demands due to failures, such as transmission link failures, in the network.

### DETAILED DESCRIPTION OF THE INVENTION

Accordingly, the present invention provides a method for designing lost cost static network with failure protection comprising:
(i) generating a set of optimized routing assignment schemes (RA) (401);
(ii) generating a set of different channel/capacity assignment scheme (CA) for a particular routing assignment scheme (402);
(iii) generating a feedback for each of the routing assignment scheme (403);
(iv) using the feedback thus obtained and determining whether any better routing assignment scheme can be arrived at (404);
(v) generating a whole new set of routing assignment schemes and repeating the steps 2 through 4 till no better routing assignment scheme is arrived at or some desired level of routing assignment scheme is reached and performing channel assignment for this set of routing assignment scheme, if a better routing assignment scheme is possible (405 and 406), and
(vi) marking the network thus obtained as a low cost static network with failure protection, if a better routing assignment scheme is not possible or the desired level of routing assignment scheme is attained.

In particular, the present invention relates to a fast and efficient method for designing static networks with failure protection. In the present design technique, Network Topology and Demands for a static network are taken as input and depending upon the protection schemes, a set of Demands and Routes are generated. A set of different Route Assignments is done and for each of the Route Assignment, Capacity Assignment is done for the complete Demand set. Capacity Assignment process also generates a feedback about possible improvements in every Route Assignment. Using this feedback a new set of Route Assignment is done and for every Route Assignment, Capacity Assignment and the feedback are once again generated. This process is iterated a number of times until there is no room for improving Route Assignment by using feedback or when we have iterated a certain number of times.

In an embodiment of the present invention, the step of generating a set of optimized RA's further comprises:
(i) taking input about the topology and demand “K” from the user;
(ii) generating a set of routing assignment scheme for each demand using any network topology known in the art (101);
(iii) storing all the demands and all possible routing assignment schemes in a Database (102), and
(iv) generating protected demands and adding them to the demands present in the Database (102).

In another embodiment of the present invention, the step of generating a set of different channel/capacity schemes for a particular routing assignment scheme further comprises:
(i) taking a particular routing assignment scheme and creating a set of different channel/assignment schemes (301);
(ii) determining whether all the demands have been assigned the required capacities (302);
(iii) generating a set of new channel assignment schemes for each of the old channel assignment schemes and selecting a subset of channel assignment scheme from the newly generated channel assignment schemes and repeating the aforesaid second sub step if all the demands have not been assigned the required capacities, and
(iv) selecting some complete channel assignment schemes and analyzing them to generate a feedback about said channel assignment scheme if all the demands have been assigned the required capacities.

In yet another embodiment of the present invention, a set of different channel/assignment schemes are created by adding only M different demands out of total K demands in each Channel Assignment scheme, wherein M is a subset of K.

In still another embodiment of the present invention, the step of generating new channel assignment schemes further comprises:
(i) taking a particular channel assignment scheme as an input;
(ii) analyzing the topology and selecting a demand and routing assignment scheme such that it is not present in the present capacity assignment scheme;
(iii) determining the type of the demands and the routes, and
(iv) assigning capacity for the route and adding them in the channel assignment.

In a further embodiment of the present invention, a set of channel assignment schemes are generated by adding N different demands other than M out of total (K-M) demands, and storing all these newly generated channel assignment scheme, wherein N is a subset of K.

In one more embodiment of the present invention, the process of selecting a subset of channel assignment scheme from the newly generated channel assignment schemes is based upon some goodness parameters.

In one another embodiment of the present invention, the goodness parameters are minimum number of transmission links used, minimum cost, maximum utilization of links and minimum number of equipments.

### BRIEF DESCRIPTION OF THE DRAWINGS

The foregoing and other aspects and advantages will be better understood from the following detailed description of a preferred embodiment of the invention with reference to the drawings in which:

FIG. 1 is a flow diagram of the procedure to generate routes and Demands.

FIG. 2 is a flow diagram of a procedure for capacity assignment for a set of Demands.

FIG. 3 is a flow diagram for CA.

FIG. 4 is a flow diagram of overall method.

FIG. 5 is an illustration of a general network example.

FIG. 6 is an illustration of different routes between nodes.

FIG. 7 is an illustration explaining using link topology to share capacity.

FIG. 8 is an illustration explaining sharing of protection capacity.

FIG. 9 is an illustration explaining sharing of service and protection capacity.

FIG. 10 and FIG. 11 are illustrations explaining use of feedback method to design more efficient networks.

The present invention is further described in detail with reference to the drawings in the preferred embodiments which are given by way of illustration and therefore, should not be construed to limit the scope of the present invention in any manner.

### DETAILED DESCRIPTION OF A PREFERRED EMBODIMENT OF THE INVENTION

The present invention more particularly relates to a fast and efficient method for designing static networks with failure protection. In the present design technique, Network Topology and Demands for a static network are taken as input and depending upon the protection schemes, a set of Demands and Routes are generated. A set of different Route Assignments is done and for each of the Route Assignment, Capacity Assignment is done for the complete Demand set. Capacity Assignment process also generates a feedback about possible improvements in every Route Assignment. Using this feedback a new set of Route Assignment is done and for every Route Assignment in set we again do the Capacity assignment and generate feedback. This process is iterated a number of times until there is no room for improving Route Assignment by using feedback or when we have iterated a certain number of times.

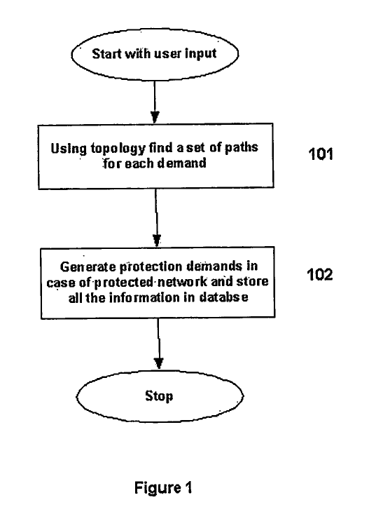

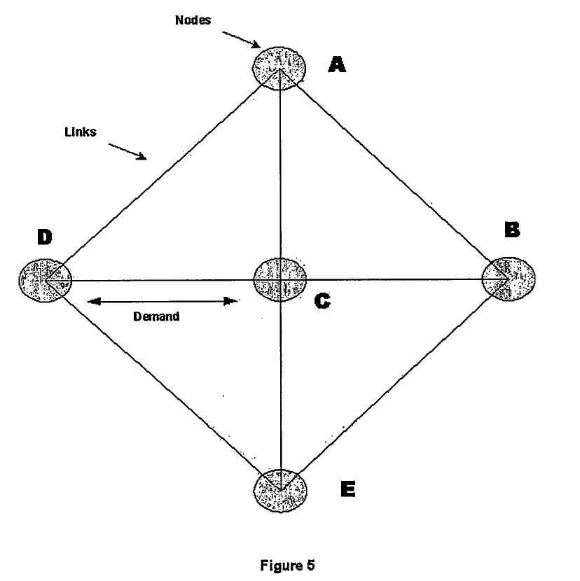

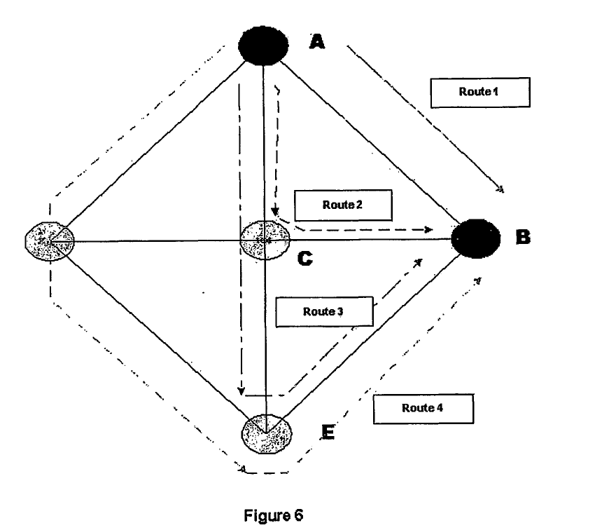

Referring now to the drawings, and more particularly to FIG. 1, a procedure is shown, which takes the input about the network topology and Demands from the user and generates a set of routes. FIG. 5 illustrates a diagram of a typical network. In block 101 for every Demand a set of routes is calculated using the network topology. An illustration about route calculation is given in FIG. 6. In block 102 all the Demands and detailed information about possible routes is kept in a database. In case of protected networks, protection Demands are generated and they are also added to the set of Demand database. Depending upon the type of protection we provide dedicated or shared capacity for the protection Demands.

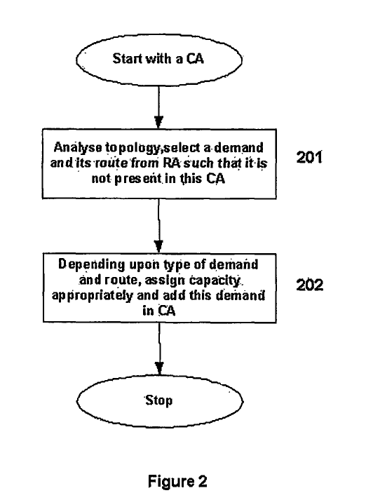

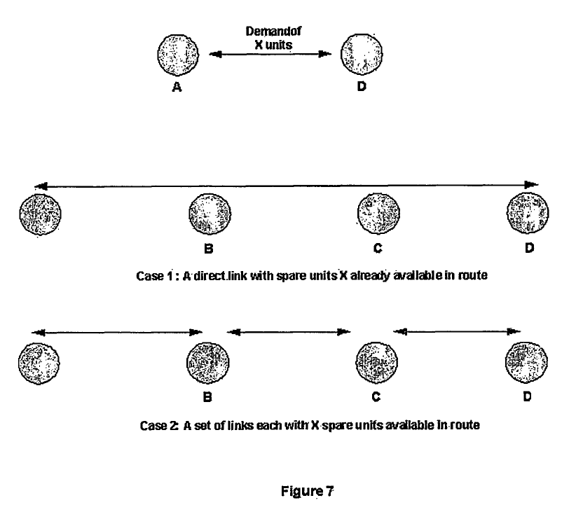

FIG. 2 explains how transmission link capacity assignment is done for a set of Demands in a network where we have already assigned link capacities to some other Demands. In block 201 it takes a particular Capacity Assignment scheme as an input, analyses it and using this information and Demand database finds out a Demand set for which we have not done Capacity Assignment in this scheme. From this Demand set it selects a subset of Demands in an intelligent manner so that Capacity Assignment can be efficient. An example is illustrated in FIG. 7 where we show one of the possible criteria of selection. In this example we have to assign X units for a Demand between node A and node D and we find that some transmission link/links (i.e. either of case 1 or case 2 in FIG. 7 is present) is already available with X spare units. This assignment for this Demand is efficient, as we are not required to add a new transmission link between node A and node D. Once the selection of Demands is done in block 201, actual assignment is done in block 202.

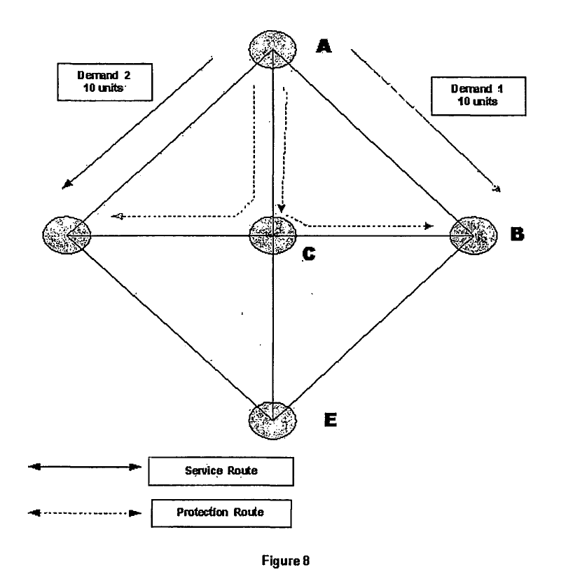

In block 202 we find all the transmission links, which Demand, will use and reserve the required capacity on them. If there is not enough capacity available then we add a new transmission link of capacity more than equal to Demand between source and destination. If the network supports a special protection mechanism such that protection Demands are also transmitted simultaneously then we assign dedicated capacity for every protected Demand else protected Demands can share capacity. For protection Demands in any link we find out what is the maximum protection capacity required in this link in case of all N simultaneous failures, where N depends upon the number of failure protection we want to support, and assign this maximum capacity on this link. In FIG. 8 we describe an example to show this concept. Let us assume that this example network supports protection against single failure and in case of failure only Demands will go on protection route. In this example there are two service Demands each of 10 units between node A and D and node A and B respectively whose protection routes have link AC in common. Here instead of reserving protection capacity of 10 units for each Demand in link AC we will reserve only 10 units in total because we are supporting only a single failure and so we assume at a time only one service route can fail and hence only one of them will use the protection capacity at a given instance.

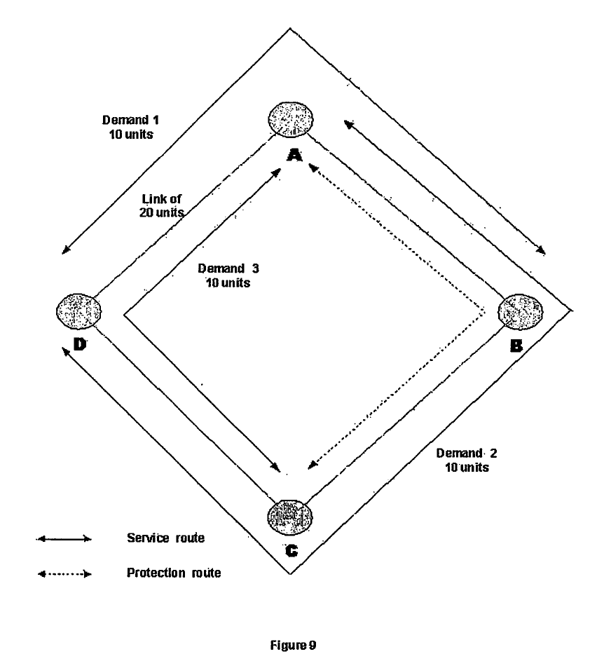

In some special cases we can share service Demands also with the protection Demands. Let us assume there is a link (A) having protected and service Demands and a failure occurs due to which some Demands switches to their protected routes which uses this link (A) and simultaneously because of this failure some working Demands on this link (A), leave this link (A) and switch to their protected route on other links (other than A). In this case those protection Demands which switched on link (A) because of the failure, can now use that reserved capacity of earlier service Demands on this link (A), which are now going on their protection routes using links other than link (A). We can get a better understanding by looking at the example illustrated in FIG. 9. Let us assume that this example network supports protection against single failure and in case of failure only Demands will switch to protection route. In this example Demand 1 is of 10 units between node D and B on links DA-AB, Demand 2 is of 10 units between node D and B on links DC-CB-BA and Demand 3 is of 10 units between node A and C on links CD-DA. Maximum capacity of any link is 20 units. Protection route for Demand AC is AB-BC. Now Demand AC will switch to protection route in two cases:
Link DA fails: In this case Demand 1 and Demand 3 switch to protection routes and assuming Demand 1 protection route does not uses links AB and BC, Demand 3 can use the capacity of 10 units in the link AB earlier reserved for Demand 1 for its protection use.
Link DC fails: In this case Demand 2 and Demand 3 switch to protection routes and assuming Demand 2 protection route does not uses links AB and BC, Demand 3 can use the capacity of 10 units in the link BC earlier reserved for Demand 2 for its protection use.

In block 202 all these checks are carried out on each link and an efficient capacity assignment is done on all the links, which selected Demands use.

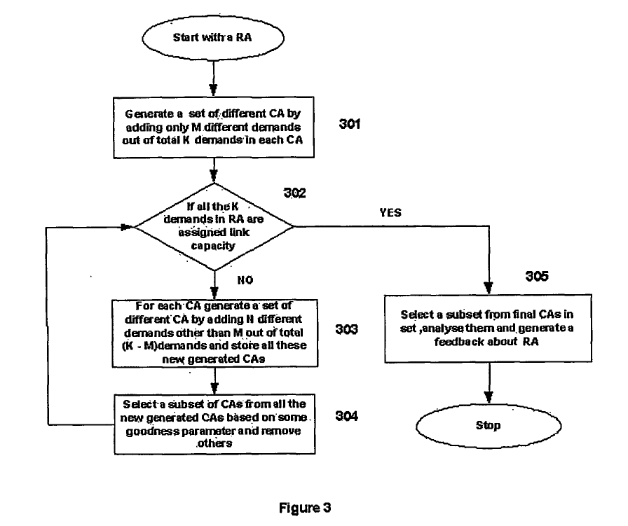

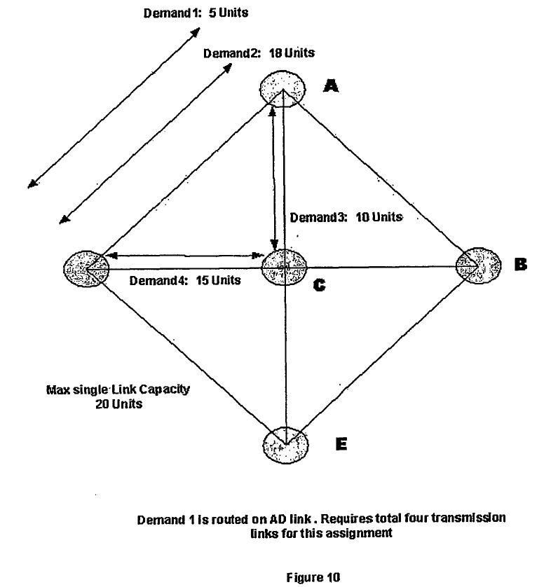

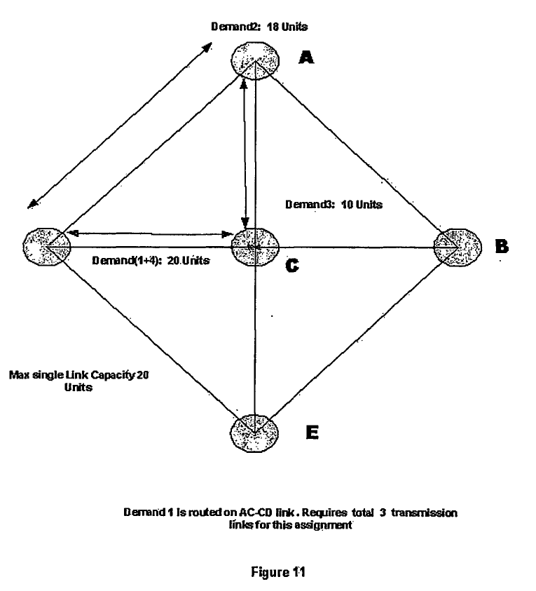

FIG. 3 explains the procedure of Channel Assignment. It takes a particular Route Assignment scheme as an input and using that information, first creates a set of different Channel Assignment schemes using only a subset of Demands, as explained in block 301. This process can be made intelligent enough so that we do a fast and efficient channel assignment. One of the examples can be that for Demands which use full transmission link capacities are assigned dedicated transmission links first. Once this process is done, in block 302 we check if all the Demands have been assigned required capacities. If some of the Demands are remaining then for each Channel Assignment scheme present in the set, we add a subset of remaining Demands in different manners using procedure explained in FIG. 2 and in this way for each CA generate a lot of new CA and store all of these in some set. This step is done in block 303 and it will result in a large number of CA. In block 304 we select a subset of CA from the set of new generated CA on the basis of some parameters, and process the selected CA in block 302. For example one of the parameters can be all the CA, which require minimum number of transmission links, are selected. This process is repeated till we assign capacities for all of the Demands. Once this process completes we go to block 305 where we select some complete Channel Assignment schemes, analyze them and generate a feedback about this Channel Assignment scheme. Let us explain an example of what feedback can be by using an example in FIG. 10. In this example we see that after doing RA two Demands of capacity 18 and 5 units are routed on link AD while one Demand of capacity 10 units and one Demand of capacity 15 is routed on link AC and CD respectively. Since the maximum capacity of a single transmission link is given as 20 units, in Channel Assignment we have to provide two transmission links on link AD to satisfy capacity requirements. If instead of routing Demand1 on link AD, we route it on link AC-CD we see that they have enough spare capacity to handle this Demand and in this manner we will require only three transmission links. CA gives this feedback to RA which using the feedback information modify its route assignment and in this way it results in a more efficient network design as shown in FIG. 11.

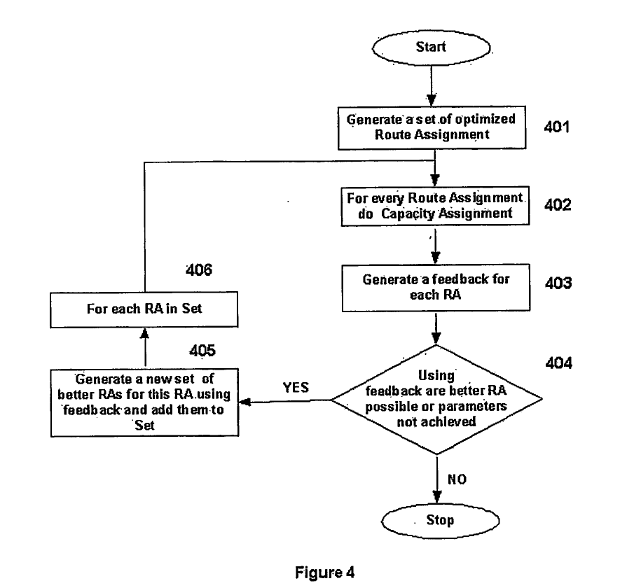

FIG. 4 describes the overall method using the procedures that we explained earlier. Using procedure explained in FIG. 1 it takes the input from user and generate all the routes and Demand database. In block 401 it generates a set of RA in some intelligent manner. An example can be generating RA using the shortest routes. Once this set is generated, in block 402 for each RA we will do the CA as explained in FIG. 3. In block 403 we get all the feedback information about RA and in 404 we will analyze this feedback information to find out if it is possible to generate better RA. If it is possible then we generate a whole new set of RA in block 405 and go back to block 402 and repeat the process until there is no way to do a better route assignment, else we do CA for final sets in RA which gives a low cost and capacity optimized network design.

1. A method for designing lost cost static network with failure protection comprising:
(i) generating a set of optimized routing assignment schemes (RA) (401);
(ii) generating a set of different Capacity Assignment scheme ( CA) for a particular routing assignment scheme (402);
(iii) generating a feedback for each of the routing assignment scheme (403);
(iv) using the feedback thus obtained and determining whether any better routing assignment scheme can be arrived at (404);
(v) generating a whole new set of routing assignment schemes and repeating the step 2 through 4 till no better routing assignment scheme is arrived at or some desired level of routing assignment scheme is reached and performing channel assignment for this set of routing assignment scheme, if a better routing assignment scheme is possible (405 and 406), and
(vi) marking the network thus obtained as a low cost static network with failure protection, if a better routing assignment scheme is not possible or the desired level of routing assignment scheme is attained.

2. A method as claimed in claim 1, wherein the step of generating a set of optimized routing assignment schemes further comprises:
(i) taking input about the topology and demand “K” from the user;
(ii) generating a set of routing assignment scheme for each demand using any network topology known in the art (101);
(iii) storing all the demands and all possible routing assignment schemes in a Database (102), and
(iv) generating protected demands and adding them to the demands present in the Database (102).

3. A method as claimed in claim 1, wherein the step of generating a set of different channel/capacity assignment scheme for a particular routing assignment scheme further comprises:
(i) taking a particular routing assignment scheme and creating a set of different channel/assignment schemes (301);
(ii) determining whether all the demands have been assigned the required capacities (302);
(iii) generating a set of new channel assignment schemes for each of the old channel assignment schemes and selecting a subset of channel assignment scheme from the newly generated channel assignment schemes and repeating the aforesaid second sub step if all the demands have not been assigned the required capacities, and
(iv) selecting some complete channel assignment schemes and analyzing them to generate a feedback about said channel assignment scheme if all the demands have been assigned the required capacities.

4. A method as claimed in claim 3, wherein the step of creating a set of different channel/assignment schemes further comprises: adding only M different demands out of total K demands in each Channel Assignment scheme, wherein M is a subset of K.

5. A method as claimed in claim 3, wherein the step of generating new channel assignment schemes further comprises:
(i) taking a particular channel assignment scheme as an input;
(ii) analyzing the topology and selecting a demand and routing assignment scheme such that it is not present in the present capacity assignment scheme;
(iii) determining the type of the demands and the routes, and
(iv) assigning capacity for the route and adding them in the channel assignment.

6. A method as claimed in claim 3, wherein the step of generating a set of channel assignment schemes further comprises adding N different demands other than M out of total (K-M) demands, storing all these newly generated channel assignment schemes, wherein N is a subset of K.

7. A method as claimed in claim 3, wherein the process of selecting a subset of channel assignment scheme from the newly generated channel assignment schemes is based upon some goodness parameters.

8. A method as claimed in claim 7, wherein the goodness parameters are minimum number of transmission links used, minimum cost, maximum utilization of links and minimum number of equipments.
